(19) United States
(12) Patent Application Publication
(10) Pub. No.: US 2003/0047015 A1
(43) Pub. Date: Mar. 13, 2003

(54) Centrifugal propulsion system

(76) Inventor: Sung-Hun Kim, Gyonggi-do (KR)

Correspondence Address: DANN DORFMAN HERRELL & SKILLMAN, SUITE 720, 1601 MARKET STREET, PHILADELPHIA, PA, 19103-2307, US

(21) Appl. No.: 10/181,994

(22) PCT Filed: Jan. 20, 2001
(86) PCT No.: PCT/KR01/00104

(30) Foreign Application Priority Data
Jan. 25, 2000 (KR) 2000-3455
Jan. 12, 2001 (KR) 2001-1729

(51) Int. Cl. F16H 21/00

(52) U.S. Cl. 74/22 R

(57) ABSTRACT

A centrifugal force propelling apparatus is provided for propelling, breaking, or shift of direction of vehicles. The apparatus comprises: a frame coupled to the vehicle; a plurality of weight bodies disposed on the frame and rotated along a track; a rotational driving unit for applying a rotational power to the weight bodies; and an angle velocity varying unit for transferring a rotational force of the rotational driving unit to the weight bodies, enabling the weight bodies to rotate in an equiangular velocity about a rotational axis of the rotational driving unit, and allowing the angular velocity to be varied about a moment rotational center.

### TECHNICAL FIELD

The present invention generally relates to a centrifugal force propelling apparatus for converting a centrifugal force of weight bodies into a linear motion, and in particular to a centrifugal force propelling apparatus, which can be used for propelling or breaking a vehicle, a railway vehicle, a ship, a submarine, an airplane, and so on, or shifting a direction thereof by varying an angular velocity of rotational weight bodies to generate a driving force, namely a resultant force exerted in one direction.

### BACKGROUND ART

As well known, bodies which are in other motion than a uniform linear motion, in other words, bodies whose velocity or direction of motion is varied, have an inertial force generated due to acceleration. The bodies following a curvilinear track go through a change of direction and velocity of motion thereof due to a force imparted from a supporting unit guiding the curvilinear motion, such that an equivalent force is inversely applied to the supporting unit as a reaction force.

In general, a centrifugal force is a force deconcentrately exerted from a center of curvature in a body following a curvilinear track. The centrifugal force is simply proportional to a mass or a radius of curvature of the rotational body and proportional to a square of an angular velocity of the rotational body. Accordingly, if the angular velocity of the body is beyond a predetermined level, the centrifugal force is appreciably increased. For example, a centrifugal force, which is encountered to a body weighing at M kg and rotating in 600 rpm along a circular orbit of 10 cm, is calculated as follows:

CF=Mrω²=M(kg)×0.1(m)×(20□)²(rad/sec)²≈394.8M(kg)(m)/sec²).

As shown in the result, the centrifugal force amounts to about 40 times a gravity (9.8M (kg)(m)/(sec²)) applied to the body weighing at M kg.

As above, since the centrifugal force permits attainment of a greater force, the centrifugal force is widely used for producing a force in drying machines and centrifugal separators as well as for producing an artificial gravity in space stations. General vehicles or submarines may attain a driving force by virtue of an action-reaction force between each wheel and a ground, or between a propeller and a water, and general airplanes may attain a floating force by virtue of an action-reaction force between a wing and an air. However, the centrifugal force has an advantage of producing a motion in a supporting unit without any reaction force generated through an external medium by directly acting on the supporting unit supporting a rotational body. Thus, there have been continuous attempts to attain a driving force for moving a body by using the centrifugal force.

For example, there are Japanese Laid-Open Nos. 6-272659, 8-284796, and 9-242660, which disclose methods for producing a driving force through the centrifugal force. The conventional centrifugal force propelling apparatuses, however, are structurally complex and less efficient since the approaches are accomplished by modifying a rotational radius of a rotational body in general, and are inadequate to be applied to vehicles or airplanes since the approaches cause a severe vibration in actual.

### DISCLOSURE OF INVENTION

It is, therefore, an object of the present invention to provide a centrifugal force propelling apparatus, which can attain a driving force in a sufficiently stable and efficient manner to ensure a linear motion of a body without a reaction force through such an external medium as a ground, an air, a water, etc.

It is another object of the present invention to provide a centrifugal force propelling apparatus of a simple structure, which is effectively applicable in various sizes for various purposes.

To achieve the above objects, there is provided a centrifugal force propelling apparatus according to the present invention, the apparatus comprising: a frame coupled to a vehicle, such as a car, a ship, an airplane, etc.; a plurality of weight bodies disposed on the frame and rotating along a track; a rotational driving unit for applying a rotational force to the weight bodies; and an angular velocity varying unit for transferring a rotational force of the rotational driving unit to the weight bodies, enabling the weight bodies to rotate in an equiangular velocity about a rotational shaft of the rotational driving unit, and allowing the angular velocity to be varied about a moment rotational center of the weight bodies.

The present invention is capable of effectively converting a centrifugal force into a driving force by varying the angular velocity, whose fine change would have a tremendous influence on the centrifugal force in view that the size of the centrifugal force is proportional to a square of the angular velocity, and also of simplifying a structure thereof by attaining a greater driving force while continuously permitting the weight bodies to rotate along the circular orbit.

The present invention is cable of being widely applied to vehicles, which are needed to shift a driving force to a discretionary direction, as well as vehicles following a track by varying a direction of a driving force through a simple operation creating a relative motion to a vehicle.

Even though a centrifugal force propelling apparatus generates a vibration to some extent in characteristic during a course that a resultant force produced due to eccentricity of the centrifugal force is used as a driving force, the vibration can be minimized by using the weight bodies as many as possible. The present invention is capable of minimizing the vibration by interconnecting the plurality of weight bodies in a ring shape, and ensuring a stable drive by disposing the angular velocity varying unit to form one or more pairs thereof and providing a rotational synchronizing unit to transfer a rotational force of the rotational driving unit to the pair of angular velocity varying units in an equiangular velocity and in the opposite direction, with a result that two rotational weight bodies form each pair and each pair of weight bodies are synchronized in the opposite direction at positions symmetrical with respect to a driving direction.

The present invention is also capable of minimizing a vibration or a couple of forces with the assistance of an angular momentum conservation force of the rotational weight bodies by providing a driving force stabilizing unit, which is comprised of a weight body rotating at high speed around the driving direction, on the frame.

### BRIEF DESCRIPTION OF THE DRAWINGS

Further objects and advantages of the invention can be more fully understood from the following detailed description taken in conjunction with the accompanying drawings, in which:

FIG. 1 is a cross view of a centrifugal force propelling apparatus according to a preferred embodiment of the present invention;

FIG. 2 is a longitudinal sectional view of the centrifugal force propelling apparatus of FIG. 1;

FIG. 3 is a plan view of the centrifugal force propelling apparatus of FIG. 1;

FIG. 4 is a conceptual view for explaining a principle of generating a driving force according as an angular velocity is varied;

FIG. 5 is a longitudinal sectional view of a centrifugal force propelling apparatus according to another preferred embodiment of the present invention;

FIG. 6 is a longitudinal sectional view of a centrifugal force propelling apparatus according to further another preferred embodiment of the present invention;

FIG. 7 is a plan view of the centrifugal force propelling apparatus of FIG. 6 in a state that a cover is removed therefrom; and

FIG. 8 is a longitudinal sectional view of a centrifugal force propelling apparatus according to still another preferred embodiment of the present invention.

### BEST MODE FOR CARRYING OUT THE INVENTION

The present invention will now be described in connection with preferred embodiments with reference to the accompanying drawings. While the invention has been shown and described with reference to certain preferred embodiments thereof, it will be understood by those skilled in the art that various changes in form and details may be made therein without departing from the spirit and scope of the invention as defined by the appended claims.

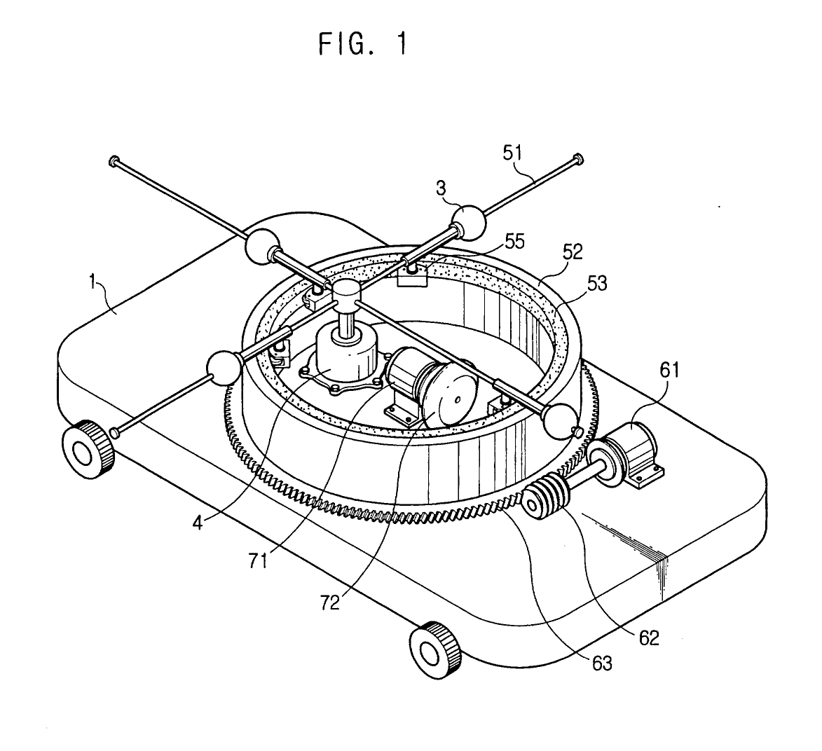

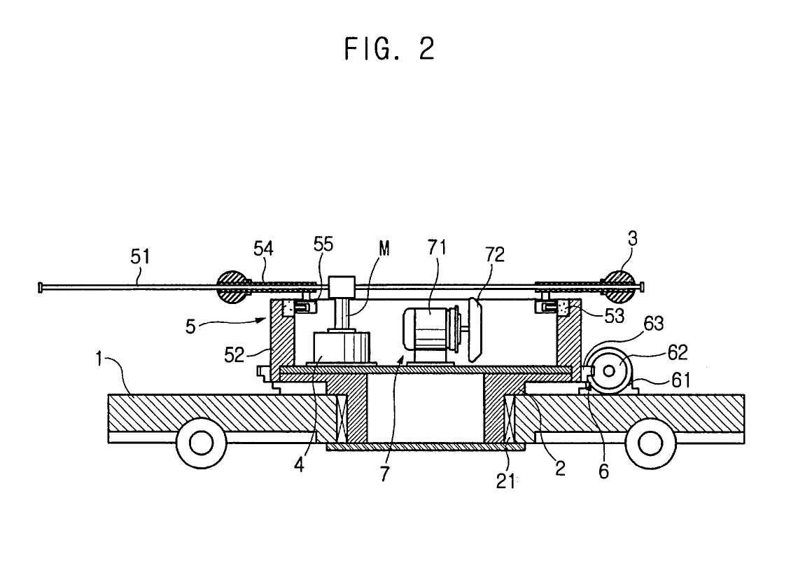

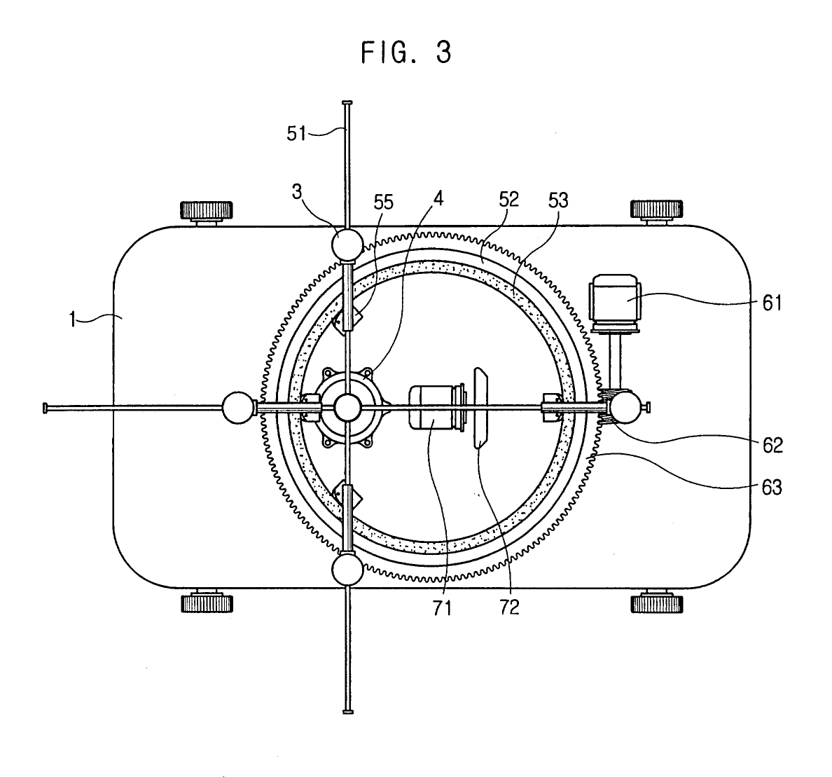

FIGS. 1 to 3 are views of a centrifugal force propelling apparatus according to a preferred embodiment of the present invention. FIG. 1 is a cross view, FIG. 2 is a longitudinal sectional view and FIG. 3 is a plan view, respectively. The centrifugal force propelling apparatus according to the preferred embodiment of the present invention comprises a frame 2 coupled to a vehicle, such as a car, a ship, an airplane, etc.; a plurality of weight bodies 3 disposed on the frame 2 and rotating along a tack; a rotational driving unit 4, such as a motor or an engine, for applying a rotational force to the weight bodies 3; an angular velocity varying unit 5 for transferring a rotational force of the rotational driving unit 4 to the weight bodies 3, enabling the weight bodies 3 to rotate in an equiangular velocity about a rotational shaft of the rotational driving unit 4, and allowing the angular velocity to be varied about a moment rotational center of the weight bodies 3; a driving direction varying unit 6 for varying a driving direction by causing the frame 2 to undergo a relative motion to the vehicle 1; and a driving force stabilizing unit 7 for decreasing a vibration or a tilt by generating an angular momentum in the driving direction through a high speed rotation.

The angular velocity varying unit 5 according to the preferred embodiment includes a plurality of arms 51 radially formed on a driving shaft M of the rotational driving unit 4; a plurality of sleeves 54 slidably coupled to the respective arms 51 and having the respective weight bodies 3 fixed at one end thereof; a cylindrical guide rail 52 eccentrically installed about the driving shaft of the rotational driving unit 4; and guide rollers 55 coupled to the sleeves 54 and conducting a circular motion along the guide rail 52 as the arms 51 rotate to enable the sleeves 54 and the weight bodies 3 to slide along the arms 51.

The guide rail 52 may be formed of a single material. However, it is desirable that the guide rail 52 is formed by forcibly fitting bearing members having high friction resistance and lubricating ability into contact portions with the guide rollers 55, so that the apparatus can be used for a long time by replacing just the bearing members, thereby reducing a maintenance cost.

The guide rollers 55 may have one wheel fixedly installed on each sleeve 54. The embodiment, however, rotatably installs the respective guide rollers 55 having two wheels on the sleeves 54 to achieve a smooth slide motion of the weight bodies.

According to the embodiment, the weight bodies 3 are installed at an end portion of the sleeves 54 to maximize a rotational radius of the weight bodies relative to the same guide rail 52. It is further possible that the weight bodies are directly installed on the guide rollers 55.

The driving direction varying unit 6 enables a steering of the vehicle 1 by varying a direction of generating a driving force in a manner where the frame 2 is rotatably installed on the vehicle 1 by means of slide bearings 21 and so on, and a warm wheel 63 is installed at a peripheral surface of the guide rail 52 to be rotated by a worm 62, which is driven by a driving mother 61. Here, a spiral angle of the worm 62 is smaller than a frictional angle, whereby a self locking condition is satisfied enough to prevent the worm 62 from being rotated from the worm wheel 63.

In contrast to the preferred embodiment, the rotational driving unit 4 may be installed on the vehicle 1, so that relative positions of the guide rail 52 and the rotational driving unit 4 can be varied. In this case, a rotational direction and a size of a driving force are variable by causing the guide rail 52 to undergo a relative motion in x-axis and y-axis directions on the plane around the rotational shaft of the rotational driving unit.

The driving force stabilizing unit 7 employs a principle of angular momentum conservation. That is to say, if an angular momentum generating weight body 72 is rotated at high speed about the driving direction by a driving motor 71, there is created an angular momentum proportional to an inertia moment and an angular velocity. The angular momentum has a tendency to maintain a constant direction like inertia, serving to preventing a vibration from being generated due to eccentricity of the weight body.

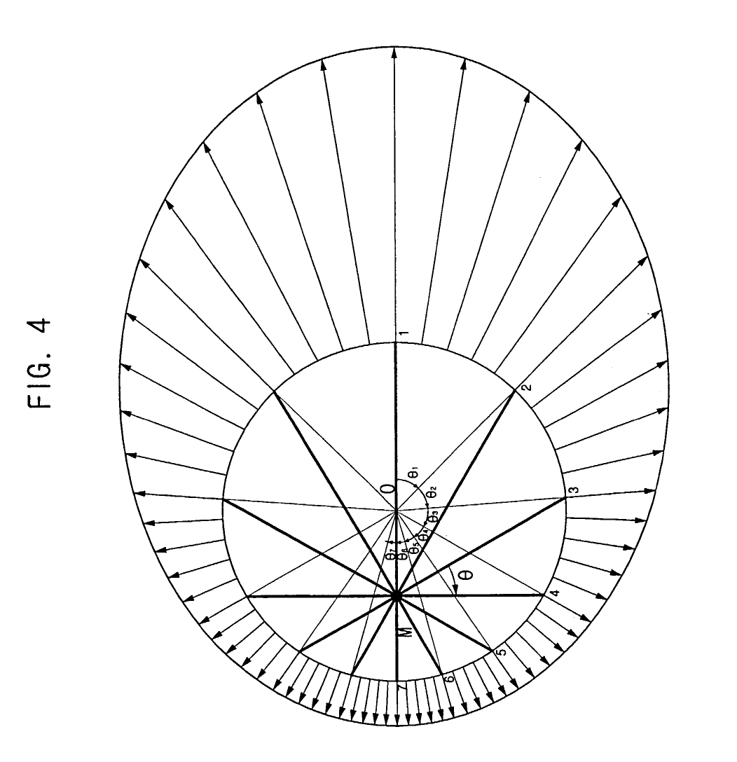

Operations and effects of the centrifugal force propelling apparatus constructed as above will be described herein below with reference to FIG. 4.

FIG. 4 is a conceptual view for explaining a principle of generating a driving force according as the angular velocity is varied, showing a positional variation of one arm 51 over time for convenience of explanation. Referring to FIG. 4, a solid line represents an arm 51 rotating at an angular velocity θ about the driving shaft M of the rotational driving unit 4 and a reference mark □ represents a rotational center of the weight body 3. Once the arm 51 is rotated by the rotational driving unit 4, there occurs the centrifugal force, acting in an outward direction of the arm 51, in the sleeve 54 coupled to the arm 51. The weight body 3 rotates along a track about the rotational center □, which is eccentrically formed about the driving shaft M by the guide rail 52 guiding the guide roller 55. In view that the arm 51 rotates at the constant angular velocity θ, as shown in FIG. 4, a moment angular velocity about the rotational center □ of the weight body 3 varies as follows: θ₁, θ₂, . . . , θ₆, θ₇. A moment angular velocity θ₁ at a time when the weight body 3 reaches a farthest position from the driving shaft M is more than three times a moment angular velocity θ₇ at a time when the weight body 3 reaches a nearest position from the driving shaft M. As aforementioned, since a centrifugal force of a body is proportional to a square of an angular velocity about a center of curvature in relation to a track of the body, the maximum centrifugal force at a certain position of the arm is more than nine times the minimum centrifugal force. Arrows in FIG. 4 represent a state where the centrifugal force is distributed as the arm rotates. If all the centrifugal forces are vector-summed, a net driving force each weight body will be attained. FIG. 4 is a view based on one weight body for convenience of explanation. However, when the weight body is plural in number, a resultant force of driving forces caused by the respective weight bodies becomes a driving force. The more number of the weight bodies are used, the less vibration is generated by the eccentric force.

There also occurs a force acting in a normal direction on the centrifugal force, not shown in FIG. 4, besides the centrifugal force outwardly acting in a direction of radius at the weight body. Since the normal directional force serves as a couple of forces for rotating the vehicle 1 in a rotational direction of the weight body, the embodiment is applicable just to a track vehicle in which rotation of the centrifugal force propelling apparatus is limited, but is not applicable to a vehicle requiring a directional shift to a discretionary direction.

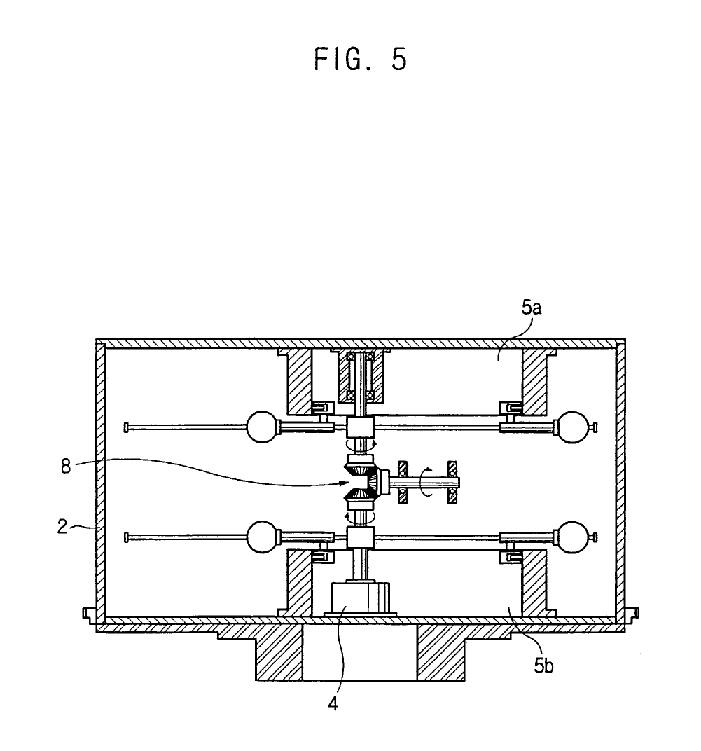

FIG. 5 is a view illustrating another preferred embodiment of the present invention for making up for the above weak point. Referring to FIG. 5, a pair of angular velocity varying units 5a and 5b are installed to rotate in opposite directions at vertically symmetrical positions of the frame 2. That is, the driving force of the rotational driving unit 4 is transferred through a rotational synchronizing unit 8 comprised of a bevel gear up to an arm of a lower angular velocity varying unit and up to an arm of an upper angular velocity varying unit at an equiangular velocity in the opposite direction, such that the corresponding arms of the lower and upper angular velocity varying units are always rotated about the driving direction in the opposite direction at the symmetrical positions. In consequence, the couple of forces for rotating the vehicle are offset and a stable driving force is attainable, whereby the embodiment is widely applicable to the vehicle requiring the shift of the driving direction to a discretionary direction as well as to the track vehicle.

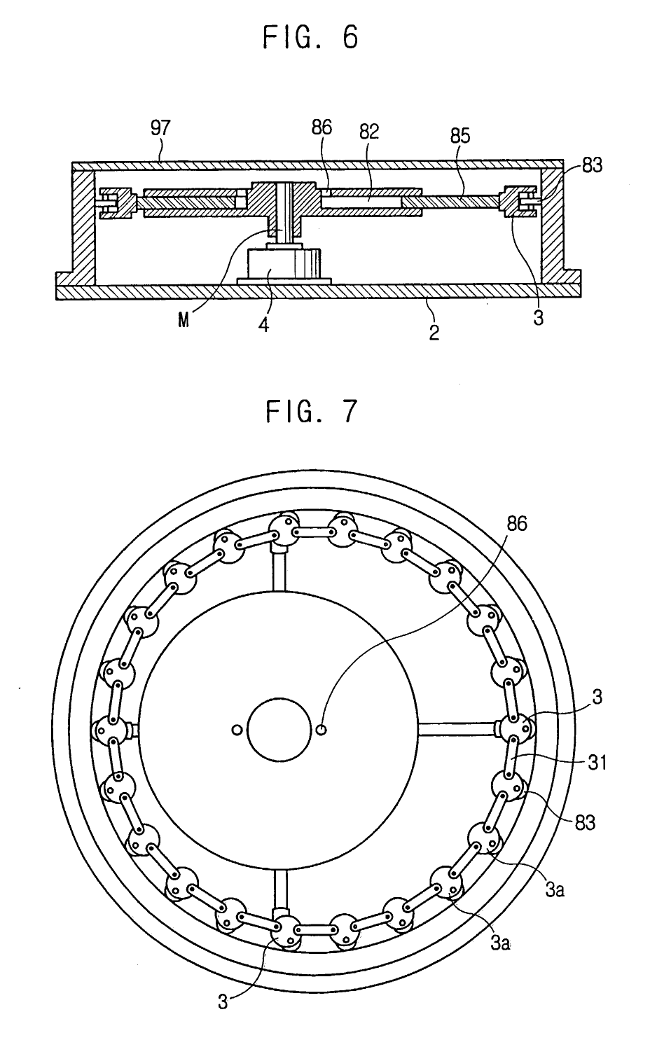

FIG. 6 and FIG. 7 are views of a centrifugal force propelling apparatus according to further another preferred embodiment of the present invention. FIG. 6 is a longitudinal sectional view of the centrifugal force propelling apparatus and FIG. 7 is a plan view of the centrifugal force propelling apparatus wherein a cover is removed. Referring to FIGS. 6 to 7, an equiangular velocity rotational body 81 on which guide routes 82 are radially formed is coupled to the rotational driving unit 4, and the weight bodies 3 are slidably coupled to the guide routes 82 by means of slide rods 85.

Guide rollers 83 are mounted on an outermost position of the weight bodies 3, and the cylindrical guide rail 52 is installed on the frame 2 to be eccentrically formed about the rotational shaft M of the rotational driving unit 4. Thus, the guide rollers 83 are guided and a circular orbit, in which the track of the weight bodies 3 is eccentrically formed about the rotational shaft, is achieved.

Meanwhile, a plurality of weight bodies 3a are movably coupled between the weight bodies 3 joined to the slide rods 85 by means of links 31.

An unexplained reference numeral 86 represents air escape holes for exhausting air inside the guide routes 82 so as not to obstruct a movement of the slide rods 85, and another unexplained reference numeral 87 represents the cover.

Similarly to the aforesaid preferred embodiments based on the basic principle that a driving force is attained by an angular velocity variation, the further another preferred embodiment enables the centrifugal force propelling apparatus to have a simple structure thereof and have an effect of rotating the continuous weight bodies by connecting the weight bodies by means of the links. As a result, a number of the guide routes 92 and of the slide rods 95 corresponding to the guide routes 92 is minimized while vibration and tilt is minimized. It is out of question that the structure of interconnecting the weight bodies is commonly applicable to the previously described preferred embodiments and other preferred embodiment to be described hereinafter.

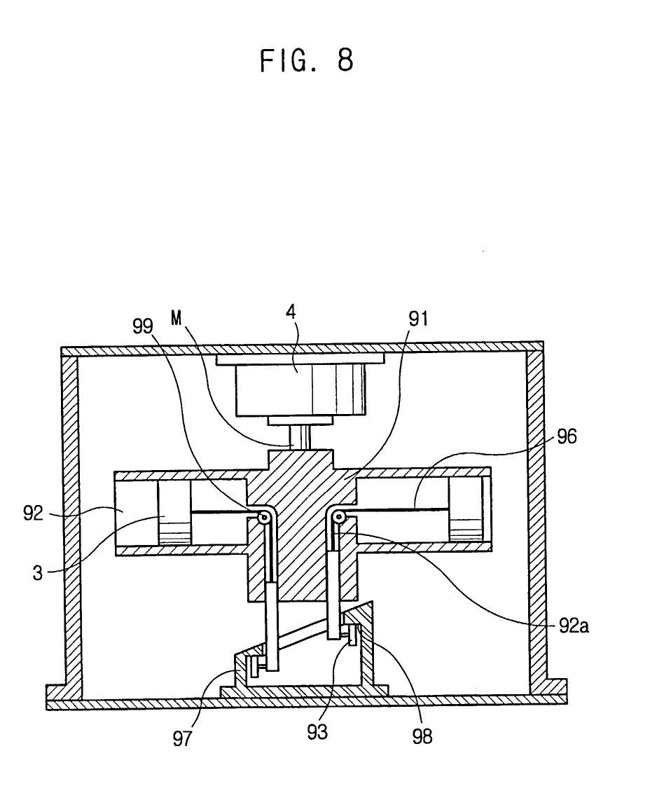

FIG. 8 is a longitudinal sectional view of a centrifugal force propelling apparatus according to still another preferred embodiment of the present invention. Referring to FIG. 8, the centrifugal force propelling apparatus includes an equiangular velocity rotational body 91 coupled to the rotational driving unit 4, and having radially cylindrical guide routes 92 to which the piston-shaped weight bodies 3 are slidably coupled, and wire guide routes 92a vertically formed on the cylindrical guide routes 92; wires 96 connected to the weight bodies 96 at one end thereof and connected to the slide rods 95 which are slidably connected to the wire guide routes 92a at other end thereof, as well as being slidably supported on support rollers 99; guide rollers 93 installed at an end portion of the slide rods 95; and a guide rail 97 having a slant guide surface 98 guiding the guide rollers 93 formed thereon.

In view of the above construction, if the equiangular velocity rotational body 91 is rotated, the slide rods 95 are vertically moved along the guide surface 98. If the slide rods 95 are at a highest position, the weight bodies 3 are rotated at a farthest position from the driving shaft M, whereas if the slide rods 95 are at a lowest position, the weight bodies 3 are rotated at a nearest position. Consequently, the angular velocity is varied in response to a difference in the rotational center of the weight bodies 3 and the driving shaft M rotating at the equiangular velocity under the same principle as that in the aforementioned preferred embodiments, thereby attaining the driving force.

### INDUSTRIAL APPLICABILITY

The centrifugal force propelling apparatus of the present invention, constructed as above, has an advantage of simplifying a structure thereof, since a centrifugal force is effectively converted into a driving force and weight bodies are continuously permitted to rotate along circular orbit while the greater driving force is attained by varying an angular velocity, whose fine change would have a tremendous influence on the centrifugal force in view that the size of the centrifugal force is proportional to a square of the angular velocity.

The centrifugal force propelling apparatus of the present invention has another advantage of being widely applicable to a vehicle requiring a shift of the driving force to a discretionary direction in addition to the track vehicle, since direction of the driving force is variable through a simple operation in which a frame is made to go through a relative motion to the vehicle.

The centrifugal force propelling apparatus of the present invention has further another advantage of permitting a stable drive, since a vibration is minimized by interconnecting the plurality of weight bodies in a ring-shape and thus achieving the effect of rotating the continuous weight bodies, and the vibration or a couple of forces are offset by synchronously rotating one or more of angular velocity varying units in the opposite direction.

The centrifugal force propelling apparatus of the present invention has yet another advantage of minimizing the vibration or the couple of forces, since an angular momentum conservation force of the rotational weight bodies is created by providing a driving force stabilizing unit, comprised of a weight body rotating at high speed about the driving direction, on the frame.

What is claimed is:

1. A centrifugal force propelling apparatus comprising:
a frame coupled to a vehicle;
a plurality of weight bodies disposed on the frame and rotating along a track;
a rotational driving unit for applying a rotational force to the weight bodies; and
an angular velocity varying unit for transferring a rotational force of the rotational driving unit to the weight bodies, enabling the weight bodies to rotate at an equiangular velocity about a rotational shaft of the rotational driving unit, and allowing the angular velocity to be varied about a rotational center of the weight bodies.

2. The centrifugal force propelling apparatus of claim 1, further comprising a driving direction varying unit for varying a direction of a driving force by causing the frame to undergo a relative motion to the vehicle.

3. The centrifugal force propelling apparatus of claim 1, wherein the angular velocity varying unit forms one or more pairs thereof, the apparatus further comprising a rotational synchronizing unit for transferring the rotational force of the rotational driving unit to the pair of angular velocity varying units in opposite directions at an equiangular velocity.

4. The centrifugal force propelling apparatus of claim 1, wherein the angular velocity varying unit is radially coupled to the rotational shaft of the rotational driving unit, and having arms on which the weight bodies are slidably coupled and a weight body guide unit for limiting a circular outer track of the weight bodies, which slide on the arms while rotating together with the arms, to be eccentrically formed about the rotational shaft of the rotational driving unit.

5. The centrifugal force propelling apparatus of claim 1, wherein the angular velocity varying unit includes an equiangular velocity rotational body coupled to the rotational driving unit and having radial guide routes to which the weight bodies are slidably coupled, and the weight body guide unit for limiting the circular outer track of the weight bodies, which slide in a direction of radius along the guide routes while rotating together with the equiangular velocity rotational body, to be eccentrically formed about the rotational shaft of the rotational driving unit.

6. The centrifugal force propelling apparatus of claim 1, wherein the angular velocity varying unit includes the equiangular velocity rotational body coupled to the rotational driving unit and having the radial guide routes thereon to which the weight bodies are slidably coupled, wires coupled to the weight bodies at one end thereof, a wire guide unit for leading the circular outer track of the weight bodies to be eccentrically formed about the rotational shaft of the rotational driving unit by varying a position of other end of the wires in response to a rotational position of the equiangular velocity rotational body.

7. The centrifugal force propelling apparatus of clam 1, further comprising a driving force stabilizing unit comprised of a weight body rotating at high speed about a driving direction on the frame.

8. The centrifugal force propelling apparatus of claim 1, wherein the plurality of weight bodies are interconnected to one another in a ring shape.
